(19) United States
(12) Patent Application Publication
(10) Pub. No.: US 2024/0065439 A1
(43) Pub. Date: Feb. 29, 2024

(54) Ulti-Wall Storage System

(71) Applicant: TNT Sports Equipment, Mitchell, SD (US)

(72) Inventor: Thomas D. Flowers, Mitchell, SD (US)

(21) Appl. No.: 18/317,695

(22) Filed: May 15, 2023

Related U.S. Application Data
(63) Continuation-in-part of application No. 29/866,131, filed on Aug. 30, 2022.

(51) Int. Cl. A47F 5/08

(52) U.S. Cl. CPC A47F 5/0838

(57) ABSTRACT

A wall mount unit having at least one bracket for hanging tools, cords, and wires from. The wall mount unit has an elongated panel and at least one bracket. The elongated panel has a front panel, a top panel, a bottom panel, and two rear lips. The top, bottom, front panel and two rear lips form a hollow unit with an internal cavity. The front panel has a central cut extending the length of the panel. The central cut has two sets of additional grooves cut into it creating a pathway that allows a specifically designed bracket to connect to the panel and slide across the central cut without having the brackets become dislodged.

### FIELD OF THE INVENTION

The present invention relates generally to a wall mount. More specifically, the present invention is a device that can hangs on the wall allowing a user to neatly hang their tools from.

### BACKGROUND OF THE INVENTION

When one is working in their garage or workmen's shop building something, often one may need multiple tools to once to complete a final project or task. Further many tools often require extension cords to be able to connect to a power source outlet which may a further distance from the tool bench than the length of cord that comes with any given power tool. Once one is done using all their tools, a workman has to pack up all their tools and clean up their workspace. A pegboard is a common method people hang their tools from. A pegboard is typically a board with holes space across the board in which a user then can hang a peg hook from the holes. However, the peg hooks often are loose, can fall out of the peg holes easily and are not very study. are a common

An objective of the present invention is to provide users with a wall mountable hanging system to hang power tools, wound up extension cords, or any other object one may need to hang in order to maintain a neat and organized working space. The present invention intends to provide users with a wall unit that is hollow on the inside. The wall unit is an elongated segment that has a groove spanning the entire length of the elongated unit. There are additional cutouts strategically placed above the groove that allow a specifically designed hook to be inserted through the groove. This connection of the hook through the groove provides a secure fit of the hooks and they won't fall out as they often do on a pegboard.

### BRIEF DESCRIPTION OF THE DRAWINGS

FIG. 1 is an isometric view of the present invention.

FIG. 2 is a front perspective view of the present invention.

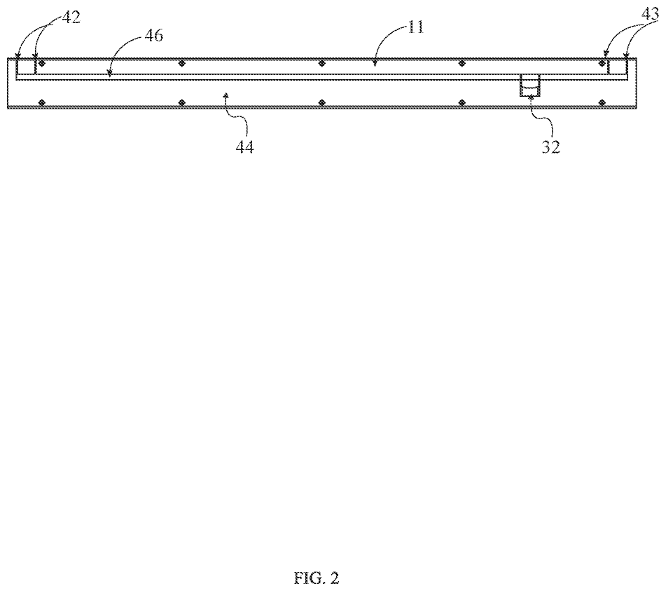

FIG. 3 is a rear perspective view of the present invention.

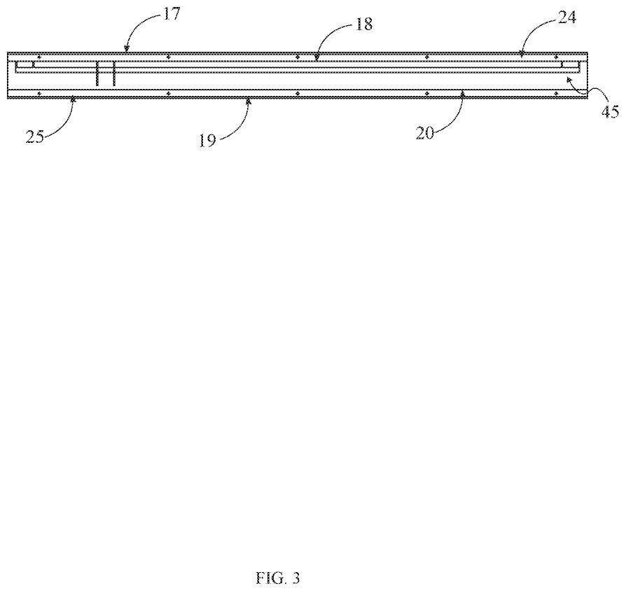

FIG. 4 is a top view of the present invention.

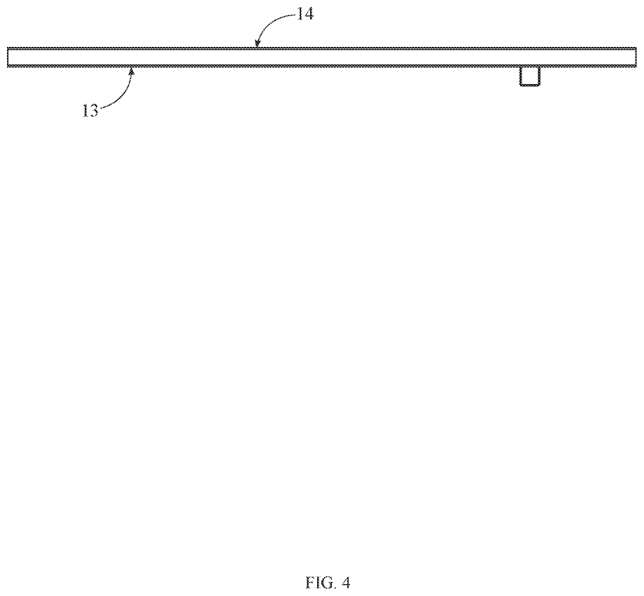

FIG. 5 is a bottom view of the present invention.

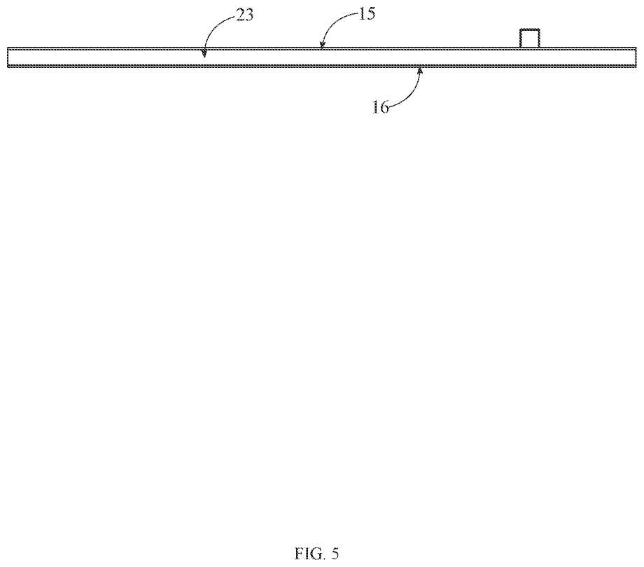

FIG. 6 is a right-side view of the present invention.

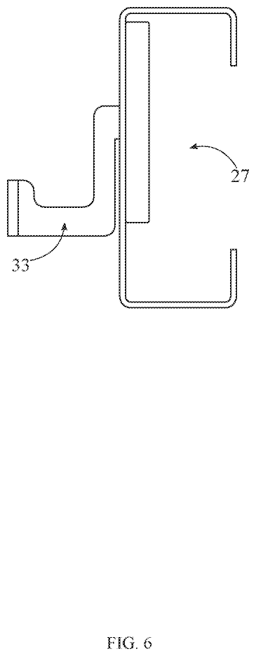

FIG. 7 is a left-side view of the present invention.

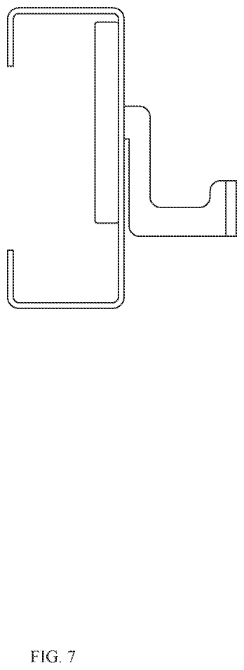

FIG. 8 is a right-side view of the bracket of the present invention.

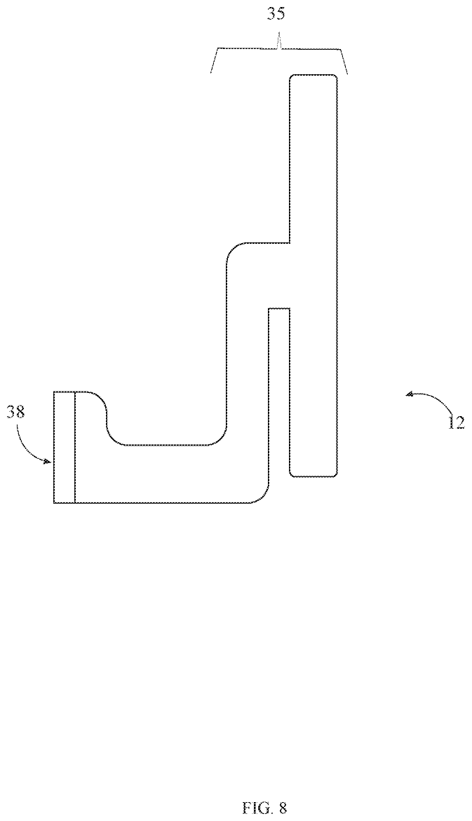

FIG. 9 is a left side view of the bracket of the present invention.

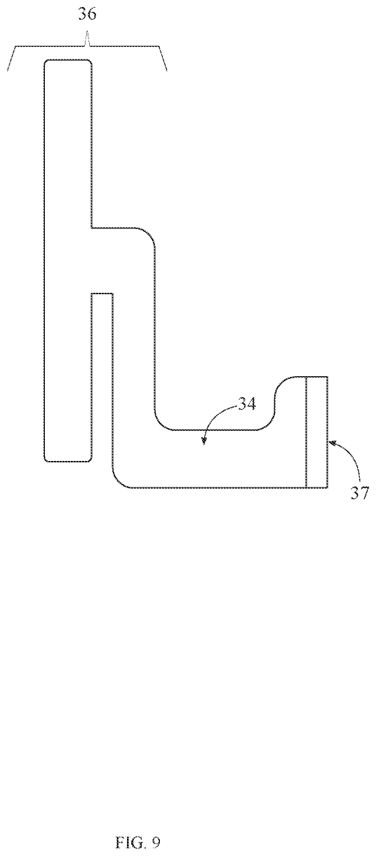

### DETAIL DESCRIPTIONS OF THE INVENTION

All illustrations of the drawings are for the purpose of describing selected versions of the present invention and are not intended to limit the scope of the present invention.

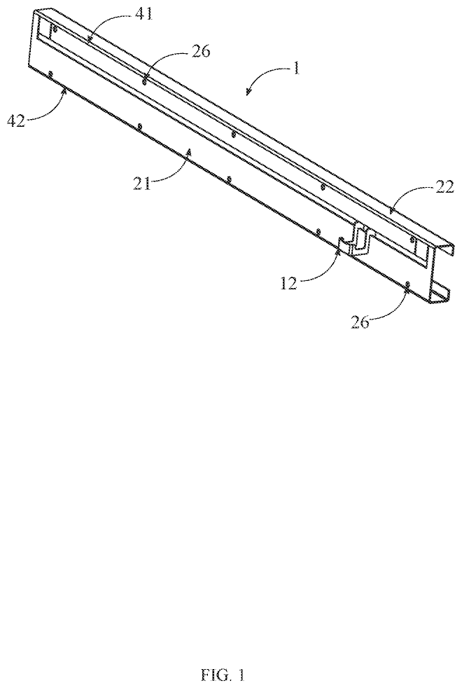

As shown in FIG. 1, the present invention is wall mount unit 1 that is equipped with at least one bracket 12 to hang objects from. An objective of the present invention is to provide users with a wall mount unit 1 that has brackets that are securely attached by way of grooves on the front of the wall mount unit. Most people use pegboards as a way to secure and hang objects but the pegs can easily fall out peg boards as the pegs simply are hooked into a hole and have no method of being securely kept in place. The present invention intends to provide users with a wall unit that provides brackets are securely held in place allowing tools, cords, wires, and other items to be hung without the risk of the peg falling out causing the tool to fall and potentially break.

To accomplish this the present invention is a wall mount unit 1 which is comprised by an elongated panel 11 and at least one bracket 12. The elongated panel 11 further comprises a front panel 21, a top panel 22, and a bottom panel 23. The elongated panel 11 further comprises an upper rear lip 24 and a lower rear lip 25. The upper rear lip 24 and lower rear lip 25 are short panels that are each only approximately one quarter the length of the front panel 21. A plurality of holes 26 are spaced along the front panel 21, upper rear lip 24 and lower rear lip 25. In its preferred embodiment, the upper rear lip 24 and lower rear lip 25 are placed flat against a wall and screws are inserted through the plurality of holes 26 securing the elongated panel 11 to a wall. The front panel 21 has an upper edge 41, a lower edge 42, and two side edges. The front panel 21 further has an outward surface 44 and inward surface 45. The outward surface 44 is the surface of the front panel that faces outward while the inward surface 45 faces in towards the internal cavity 27. The panel is defined by a rectangular shape. The top panel 22 has a front edge 13, which sits closer to the user of the wall mount, and a rear edge 14, which abuts the surface the wall mount is hung from. The bottom panel 23 has a forward edge 15 and a rearward edge 16. In the same manner as the top panel 22, the rearward edge 16 abuts the surface the wall mount is hung from while the frontward edge is closer to the user of the wall mount.

The wall mount is formed by the upper edge 41 of the front panel 21 connecting to the front edge 13 of the top panel 22 and the lower edge 42 of the front panel 21 connecting to the forward edge 15 of the bottom panel 23. The front panel 21 connects to the top panel 22 at a 90-degree angle. The front panel 21 connects to the bottom panel 23 at a 90-degree angle. The top panel 22 and bottom panel 23 are the same length as the front panel 21. The upper rear lip 24 has a first edge 17 and a second edge 18. The lower rear lip 25 has a first edge 19 and a second edge 20. The first edge 17 of the upper rear lip 24 connects to the rear edge 14 of the top panel 22 at a 90 degree angle. The first edge 19 of the lower rear lip 25 connects to the rearward edge 16 of the bottom panel 23 at a 90-degree angle. The two rear lips, the top panel 22, the bottom panel 23, and the front panel 21 form a hollow tube-like structure creating an internal cavity 27. This internal cavity 27 creates space needed to allow the bracket 12 to connect to the elongated panel 11 and have small to slide along the central cut 46, which is a cutout spanning the length of the front panel 21. The central cut 46 extends from the outward surface 44 of the front panel 21 all the way through to the inward surface 45 of the front panel 21 creating a hole. This central cut 46 traverses the length of the front panel 21.

The front panel 21 has two sets of bracket grooves. Each set of bracket grooves are two small parallel cuts in the front panel 21 that allow a bracket 12 to be attached to the elongated panel 11. The first set of bracket grooves 42 and second set of bracket grooves 43 extend up from the central cut 46 to the top edge of the front panel 21. The first set of bracket grooves 42 is positioned on one end of the central cut 46. The second set of bracket grooves 43 is positioned on the other end of the central cut. The at least one bracket is slidably attached to the front panel 21 by way of the first and second bracket grooves.

Each of the at least one brackets has a front face 32, a first resting support beam 33 and a second resting support beam 34. The first resting support beam 33 and a second resting support beam 34 are beams that extend out from the front face 32 of the bracket. These supporting beams are the surface that the tool, cord, wire, or hanging objects rests upon when hung on the bracket. Each of the at least one brackets further comprises a first hooking mechanism 35 and a second hooking mechanism 36. Each hooking mechanism is a lower case H-shaped unit. Each hooking mechanism rests on the surface that is created by the central cut 46. The front face 32 of the bracket has a left edge 37 and a right edge 38. The first resting support beam 33 is connected to the left edge 37 of the front face. The second resting support beam 34 is connected to the right edge 38 of the front face of the bracket 12. The first hooking mechanism 35 being fused to the first resting support beam 33 opposite the left edge 37 of the front face 32. The second hooking mechanism 36 being fused to the resting support beam opposite the right edge 38 of the front face.

Although the invention has been explained in relation to its preferred embodiment, it is to be understood that many other possible modifications and variations can be made without departing from the spirit and scope of the invention.

What is claimed is:

1. A wall mount comprising:
an elongated panel;
at least one bracket;
the elongated panel comprising a front panel;
the elongated panel comprising a top panel and a bottom panel
the elongated panel comprising an upper rear lip, and a lower rear lip;
the front panel having an upper edge, a lower edge, and two side edges;
the top panel having a front edge and a rear edge;
the front panel having an outward surface and an inward surface; and
the bottom panel having a forward edge and a rearward edge.

2. A wall mount as claimed in claim 1 comprising:
the upper edge of the front panel connecting to the front edge of the top panel; and
the lower edge of the front panel connecting to the forward edge of the of the bottom panel.

3. A wall mount as claimed in claim 1 comprising:
the front panel connecting to the top panel at a 90 degree angle; and
the front panel connecting to the bottom panel at a 90 degree angle.

4. A wall mount as claimed in claim 1 comprising:
the upper rear lip having a first edge and a second edge;
the first edge of the upper rear lip connecting to the rear edge of the top panel;
the lower rear lip having a first edge and a second edge;
the first edge of the second rear lip connecting to the rearward edge of the bottom panel; and
and internal cavity being formed by the front panel, top panel, bottom panel, first rear lip, and second rear lip.

5. The wall mount as claimed in claim 1 comprising:
the front panel having a central cut;
the front panel having a first set and second set of bracket grooves; and
the central cut extending from the outward surface of the front panel to the inward surface of the front panel.

6. The wall mount as claimed in claim 5 comprising:
the central cut traversing the length of front panel;
a plurality of holes being spaced along the front panel, the first rear lip and second rear lip; and
the at least one bracket further comprising a front face, a first resting support beam, and a second resting support beam.

7. The wall mount as claimed in claim 6 comprising:
the first set of bracket grooves being positioned on one end of the central cut;
the second set of bracket grooves being positioned on one of the central cut opposite the first set of bracket grooves;
the at least one bracket being slidably attached to the front by panel by way of the first and second bracket grooves; and
the at least one bracket further comprising a first hooking mechanism, a second hooking mechanism.

8. The wall mount as claimed in claim 6 comprising:
the front face having a left edge and a right edge;
the first resting beam being connected to the left edge of the front face;
the second resting beam being connected to the right edge of the front face;
the first hooking mechanism being fused to the first resting support beam opposite the left edge of the front face; and
the second hooking mechanism being fused to the resting support beam opposite the right edge of the front face.

9. A wall mount unit comprising:
an elongated panel;
at least one bracket;
the elongated panel comprising a front panel;
the elongated panel comprising a top panel and a bottom panel
the elongated panel comprising an upper rear lip, and a lower rear lip;
the front panel having an upper edge, a lower edge, and two side edges;
the top panel having a front edge and a rear edge;
the front panel having an outward surface and an inward surface;
the bottom panel having a forward edge and a rearward edge;
the upper edge of the front panel connecting to the front edge of the top panel;
the lower edge of the front panel connecting to the forward edge of the of the bottom panel;
the front panel connecting to the top panel at a 90 degree angle; and
the front panel connecting to the bottom panel at a 90 degree angle.

10. A wall mount as claimed in claim 9 comprising:
the upper rear lip having a first edge and a second edge;
the first edge of the upper rear lip connecting to the rear edge of the top panel;
the lower rear having a first edge and a second edge;
the first edge of the second rear lip connecting to the rearward edge of the bottom panel;
internal cavity being formed by the front panel, top panel, bottom panel, first rear lip,
and second rear lip;
the front panel having a central cut;
the front panel having a first set and second set of bracket grooves;
the central cut extending from the outward surface of the front panel to the inward surface of the front panel; and
the at least one bracket further comprising a front face, a first resting support beam, and a second resting support beam.

11. The wall mount as claimed in claim 9 comprising:
the central cut traversing the length of front panel; and
a plurality of holes being spaced along the front panel, the first rear lip and second rear lip.

12. The wall mount as claimed in claim 9 comprising:
the first set of bracket grooves being positioned on one end of the central cut;
the second set of bracket grooves being positioned on one of the central cut opposite the first set of bracket grooves;
the at least one bracket being slidably attached to the front by panel by way of the first and second bracket grooves; an
the at least one bracket further comprising a first hooking mechanism, a second hooking mechanism;
the front face having a left edge and a right edge;
the first resting beam being connected to the left edge of the front face;
the second resting beam being connected to the right edge of the front face;
the first hooking mechanism being fused to the first resting support beam opposite the left edge of the front face; and
the second hooking mechanism being fused to the resting support beam opposite the right edge of the front face.

13. A wall mount unit comprising:
an elongated panel;
at least one bracket;
the elongated panel comprising a front panel;
the elongated panel comprising a top panel and a bottom panel
the elongated panel comprising an upper rear lip, and a lower rear lip;
the front panel having an upper edge, a lower edge, and two side edges;
the top panel having a front edge and a rear edge;
the front panel having an outward surface and an inward surface; and
the bottom panel having a forward edge and a rearward edge.

14. A wall mount as claimed in claim 13 comprising:
the upper edge of the front panel connecting to the front edge of the top panel;
the lower edge of the front panel connecting to the forward edge of the of the bottom panel;
the upper rear lip having a first edge and a second edge; and
the first edge of the upper rear lip connecting to the rear edge of the top panel;

15. The wall mount as claimed in claim 13 comprising:
the front panel connecting to the top panel at a 90 degree angle;
the front panel connecting to the bottom panel at a 90 degree angle;
the lower rear having a first edge and a second edge;
the first edge of the second rear lip connecting to the rearward edge of the bottom panel; and
and internal cavity being formed by the front panel, top panel, bottom panel, first rear lip, and second rear lip.

16. The wall mount as claimed in claim 13 comprising:
the front panel having a central cut;
the front panel having a first set and second set of bracket grooves;
the central cut extending from the outward surface of the front panel to the inward surface of the front panel;
the central cut traversing the length of front panel.

17. The wall mount as claimed in claim 13 comprising:
a plurality of holes being spaced along the front panel, the first rear lip and second rear lip.

18. The wall mount as claimed in claim 16 comprising:
the at least one bracket further comprising a front face, a first resting support beam, and a second resting support beam;
the first set of bracket grooves being positioned on one end of the central cut;
the second set of bracket grooves being positioned on one of the central cut opposite the first set of bracket grooves; and
the at least one bracket being slidably attached to the front by panel by way of the first and second bracket grooves.

19. The wall mount as claimed in claim 13:
the at least one bracket further comprising a first hooking mechanism, a second hooking mechanism;
the front face having a left edge and a right edge;
the first resting beam being connected to the left edge of the front face;
the second resting beam being connected to the right edge of the front face;
the first hooking mechanism being fused to the first resting support beam opposite the left edge of the front face; and
the second hooking mechanism being fused to the resting support beam opposite the right edge of the front face.
